(19) United States
(12) Patent Application Publication
(10) Pub. No.: US 2012/0088019 A1
(43) Pub. Date: Apr. 12, 2012

(54) SYSTEM, METHOD AND APPARATUS FOR LOWERING ACRYLAMIDE LEVEL IN A BAKED FOOD PRODUCT

(75) Inventors: Wilfred M. BOURG, JR., Melissa, TX (US); Lamar ELONY, McKinney, TX (US)

(73) Assignee: FRITO-LAY NORTH AMERICA, INC., Plano, TX (US)

(21) Appl. No.: 12/899,998

(22) Filed: Oct. 7, 2010

(51) Int. Cl. A47J 37/06; A23L 1/01; A23L 1/216

(52) U.S. Cl. 426/466; 99/326

(57) ABSTRACT

Disclosed is an improved system, method and apparatus for reducing the level of acrylamide formed in a baked food product. A combination of belt speed, absolute humidity, air flow, pressure drop and heat input are used in temperature constrained ovens to more accurately control the baking profile of food pieces.

### BACKGROUND OF THE INVENTION

1. Technical Field

The present invention relates to an improved method for producing a baked food product having a reduced level of acrylamide variability with improved flavor. More specifically, the present invention relates to a method and apparatus to enhance product quality by lowering the acrylamide levels in a baked food product while still forming flavor enhancing compounds during baking.

2. Description of Related Art

The chemical acrylamide has long been used in its polymer form in industrial applications for water treatment, enhanced oil recovery, papermaking, flocculants, thickeners, ore processing and permanent-press fabrics. Acrylamide precipitates as a white crystalline solid, is odorless, and is highly soluble in water (2155 g/L at 30° C.). Synonyms for acrylamide include 2-propenamide, ethylene carboxamide, acrylic acid amide, vinyl amide, and propenoic acid amide. Acrylamide has a molecular mass of 71.08, a melting point of 84.5° C., and a boiling point of 125° C. at 25 mmHg.

In recent times, a wide variety of foods have tested positive for the presence of acrylamide monomer. Acrylamide has especially been found primarily in carbohydrate food products that have been heated or processed at high temperatures. Examples of foods that have tested positive for acrylamide include coffee, cereals, cookies, potato chips, crackers, french-fried potatoes, breads and rolls, and fried breaded meats. In general, relatively low contents of acrylamide have been found in heated protein-rich foods, while relatively high contents of acrylamide have been found in carbohydrate-rich foods, compared to non-detectable levels in unheated foods.

It would be desirable to develop one or more methods of reducing the level of acrylamide in the end product of heated or thermally processed foods. Ideally, such a process should substantially reduce or eliminate the acrylamide in the end product without adversely affecting the quality and characteristics of the end product.

### SUMMARY OF THE INVENTION

The proposed invention provides a system, apparatus and method for making a baked food product having a reduced level of acrylamide while retaining the flavor notes that are characteristic of a baked food product. In one aspect, the invention is directed towards a system for drying food piece preforms comprising a primary and secondary dryer. In the primary dryer, total water flow through the system is used to control the drying profile of the food piece preforms. The system uses adjustments in belt speed as a first response to a moisture disturbance, and adjustments in air velocity and energy input into the system as a second or third response, and returns the belt speed back to its set point. In the second dryer, a moisture disturbance is indicated by a change in absolute humidity in the exhaust stream. The oven temperature in the secondary dryer is tightly constrained between 110° C. and 113° C. Adjustments in oven temperature quickly reach the constraint when it is used as a first response to a moisture disturbance, so air velocity flowing through the oven is adjusted using recirculation fan speed as a second response. The system then adjusts the exhaust fan speed as a third response, and returns the oven temperature and recirculation fan speed back to a set point.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side view of one embodiment of the present invention;

FIG. 2 is cut away side view of a secondary dryer in accordance with one embodiment of the present invention; and

FIG. 3 is side view of a primary dryer in accordance with one embodiment of the present invention.

### DETAILED DESCRIPTION

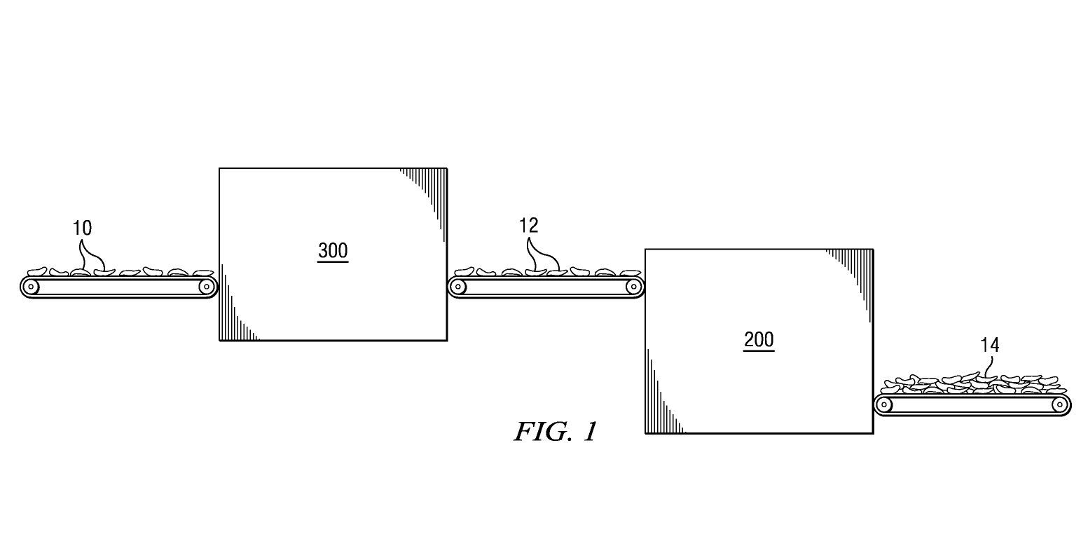

An embodiment of the innovative invention will now be described with reference to FIG. 1, which is a general flow chart of a method for making a baked food product with reduced levels of acrylamide. Food product preforms are baked in a first, primary dryer 300 or oven and then transferred to a secondary, finishing dryer 200 or oven. Food product preforms can be pieces of whole food products (discrete units of food), such as potato slices or whole vegetable pieces, or fabricated preforms, such as dough pieces cut from a sheeted dough. Upon exiting the finishing dryer, the baked food products typically have a moisture content of less than about 2%. The preforms are typically monolayered in the first oven, and bedded in the second oven.

The term “fabricated,” when used in reference to a food product, means a food product that uses as its starting ingredient something other than the original and unaltered starchy starting material. For example, fabricated snacks include fabricated potato chips that use a dehydrated potato product as a starting material and corn chips that use masa flour as its starting material. It is noted here that the dehydrated potato product can be potato flour, potato flakes, potato granules, or other forms in which dehydrated potatoes exist. When any of these terms are used in this application, it is understood that all of these variations are included. By way of example only, and without limitation, examples of “fabricated foods” include tortilla chips, corn chips, potato chips made from potato flakes and/or fresh potato mash, multigrain chips, corn puffs, wheat puffs, rice puffs, crackers, breads (such as rye, wheat, oat, potato, white, whole grain, and mixed flours), soft and hard pretzels, pastries, cookies, toast, corn tortillas, flour tortillas, pita bread, croissants, pie crusts, muffins, brownies, cakes, bagels, doughnuts, cereals, extruded snacks, granola products, flours, corn meal, masa, potato flakes, polenta, batter mixes and dough products, refrigerated and frozen doughs, reconstituted foods, processed and frozen foods, breading on meats and vegetables, hash browns, mashed potatoes, crepes, pancakes, waffles, pizza crust, peanut butter, foods containing chopped and processed nuts, jellies, fillings, mashed fruits, mashed vegetables, alcoholic beverages such as beers and ales, cocoa, cocoa powder, chocolate, hot chocolate, cheese, animal foods such as dog and cat kibble, and any other human or animal food products that are subject to sheeting or extruding or that are made from a dough or mixture of ingredients. The use of the term “fabricated foods” herein includes fabricated snacks as previously defined. The use of the term “food products” herein includes all fabricated snacks and fabricated foods as previously defined.

As referred to herein, the baked foods include, by way of example and without limitation, all of the foods previously listed as examples of fabricated snacks and fabricated foods, as well as French fries, yam fries, other tuber or root materials, cooked vegetables including cooked asparagus, onions, and tomatoes, coffee beans, cocoa beans, coffee, cooked meats, dehydrated fruits and vegetables, dried foods such as soup and dip mixes, heat-processed animal feed, tobacco, tea, roasted or cooked nuts, soybeans, molasses, sauces such as barbecue sauce, plantain chips, apple chips, fried bananas, and other cooked fruits.

Acrylamide is currently thought to form as a byproduct of, or concurrently with, the Maillard browning reactions that occur when amino acids and reducing sugars in foods are heated. It is undesirable to form acrylamide in heated foods. However, the other products of the Maillard browning reactions include desirable flavoring compounds that give richness and depth to the flavors of cooked food products. The present invention allows a practitioner to form some of the desirable flavoring compounds associated with the Maillard browning reactions, while dramatically reducing the amount of acrylamide formed during heating.

The process depicted in FIG. 1 can be used, for example, to make baked potato chips, pretzels, or pita chips. Raw ingredients, such as potato flakes, water, and starches are mixed together in a mixer to make a dough having a moisture content of between about 30% and about 40%. The dough can be sheeted in a sheeter and cut by a cutter into preforms 10. The preforms can be routed in a monolayer fashion to a first oven 300. In one embodiment, the first oven is a gas-fired impingement oven. Here the preforms can be exposed to oven temperatures of between about 300° F. and about 600° F. for between about 90 seconds and about 35 minutes. The moisture content of the preforms 12 exiting the first oven 300 is typically about 9% to about 12% by weight. The preforms 12 can optionally be sent through a curing stage where preforms are exposed to ambient air for about 15 seconds to about 3 minutes to equilibrate moisture throughout the preform. The preforms can then be sent to a multi-zone finish drying oven 200 to lower the moisture content below about 2% by weight, and in one embodiment between about 0.5% to about 2% by weight. The product can then be seasoned and packaged. Unlike the first oven 300 where the preforms are in a monolayer arrangement, the preforms in the second oven can be bedded.

Applicants herein have determined that the majority of acrylamide formed in the foregoing process is formed in the second dryer. Therefore, in one embodiment of the present invention, the operating conditions and control systems of the second dryer are modified over the prior art to reduce the level of acrylamide formation. As stated previously, the formation of acrylamide can be reduced by baking food products at product temperatures below about 120° C. when the moisture content of the food product is low. However, drying food products, especially potato slices or potato flake dough preforms, at sufficiently low temperatures produces a potato chip that is described by some as cardboard-like in flavor and texture. Applicants herein have surprisingly discovered that baking food products at an oven temperature that is tightly constrained between about 110° C. and 113° C. retains the benefits of reduced acrylamide formation, but still allows the food products to form some of the Maillard browning reaction products that contribute to the desirable flavor of cooked foods, such as certain aldehydes and ketones. In fact, consumer testing data has shown that fabricated potato chips made according to one embodiment of the present invention involving this tight temperature lowered the overall level of acrylamide by more than 50% over previous processes, but tested at parity among consumers for overall acceptability, and appearance, texture, flavor, and aftertaste acceptability.

Because the temperature inside the second dryer is so tightly constrained, other control variables are used to ensure that the moisture content of the baked food pieces exiting the second dryer remains below the desired threshold for shelf and microbial stability of the particular food product. In one embodiment, the final moisture content of the food products exiting the secondary dryer is between 0.9% and 1.9%. In a preferred embodiment, the moisture content is about 1.65%. This final moisture content is primarily obtained by monitoring changes in the absolute humidity in the exhaust air exiting the secondary dryer, and adjusting the fan speed in the exhaust and recirculation streams accordingly.

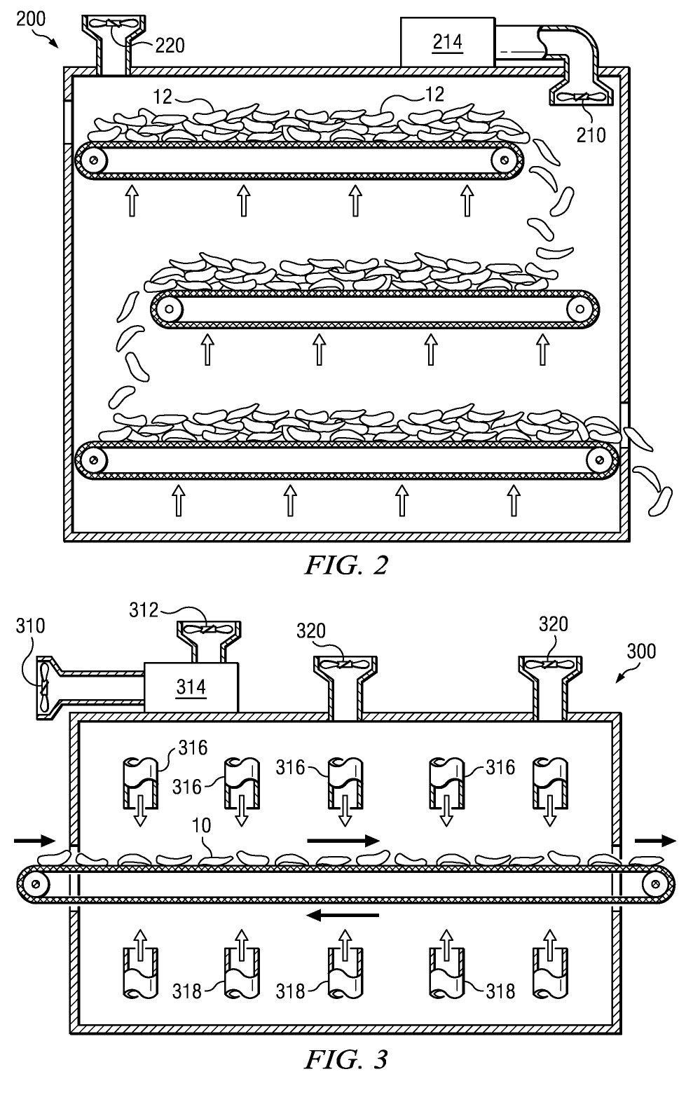

FIG. 2 depicts a multi-pass secondary dryer that can be used with the present invention. The partially dried food products 12 enter the secondary dryer as a product bed on a conveyor, and pass back and forth through the oven on a series of conveyors. Recirculation fans 210 blow heated air, recycled from the secondary dryer, from a burner house 214 (typically a gas fed burner) into the secondary dryer at various locations, and exhaust fans 220 in the exhaust stream remove air from the secondary dryer to create a flow of hot air through the product beds and maintain a slight negative pressure inside the dryer. The air entering the secondary dryer from the recirculation fan is directed to the bottom of the secondary dryer using baffles (not shown), so the hot air will travel up through the product bed and out the exhaust. The recirculation stream comprises an outlet and inlet stream (each of which may comprise more than one fan or physical location). The dryer may comprise more than one burner house, and more than one exhaust stream.

An absolute humidity sensor (not shown) is included in the exhaust stream. The term absolute humidity, as used herein, is defined as the mass of water vapor in the air divided by the mass of dry air. Air velocity sensors are used to determine the mass of dry air in the absolute humidity calculation. Pressure sensors are used to measure the pressure above and below each product bed on the conveyors, and the outlet pressure in the exhaust and recirculation streams. Temperature sensors monitor the air temperature inside the secondary dryer, and the temperatures in the outlet and recirculation streams.

Applicants herein have determined that the absolute humidity of the exhaust stream exiting the secondary dryer is an excellent parameter to monitor for changes, because a change in absolute humidity from baseline is indicative of a moisture disturbance in the baking process. Absolute humidity is measured periodically, and in a preferred embodiment, about every 5 to 30 seconds. An increase in absolute humidity in the exhaust stream indicates to the control system that the partially baked food pieces entering the secondary dryer have a higher moisture content than previously entering food pieces. If dryer operating conditions are left undisturbed, these food pieces will have an undesirably high moisture content when they exit the secondary dryer. The present invention uses a novel combination of equipment and control scheme to attenuate any moisture disturbance detected by the system.

In one embodiment of the present invention, the first response of the control system to an increase in absolute humidity is to increase the temperature of the inlet stream air. However, because the air temperature in the oven is so tightly constrained, the maximum air temperature allowed by the control system is quickly reached. When the upper constraint on air temperature is reached, the control system increases the recirculation fan speed as a second response to an increase in absolute humidity. This increase in recirculation fan speed increases the velocity of air flowing through the product bed, thereby increasing the heat transfer coefficient between the hot air and the food pieces, drying the food pieces more quickly. By drying the food pieces more quickly, the moisture disturbance is attenuated. The recirculation inlet fan speed is also increased to minimize the pressure difference above and below the product bed.

The adjustment in temperature and recirculation fan speed is typically sufficient to compensate for and attenuate moisture disturbances to the system. However, in order to bring the temperature and recirculation fan speeds back (up or down) to the desired set point, the exhaust fan speed is adjusted, which takes moisture out of the system when increased or leaves moisture in the system when decreased, and allows the control system to return the temperature and recirculation fan speeds to their mean-centered condition or set point.

The foregoing control scheme in the secondary dryer has been found to maintain uniform drying conditions inside the secondary dryer regardless of the type of moisture disturbance in the system based on characteristics of the partially dried preforms that enter the secondary dryer. Moisture disturbances to the system include product throughput variances, moisture absorption and release properties of starting ingredients (especially potato flakes), moisture content of preforms entering dryer, and others. For example, all other things being equal, an increase in product throughput will increase the absolute humidity in the exhaust streams. Consequently, the control system for the secondary dryer can increase the temperature and recirculation fan speeds to temporarily increase the drying rate of the preforms inside the system, and then increase the exhaust fan speed in order to return the recirculation fan speed and temperature back to their mean centered condition or set point.

Applicants herein have also determined that it is desirable to use the recirculation fan speed and exhaust fan speed to approximately equalize the pressure above and below the product bed. In one embodiment, the pressure on the exhaust side of the product bed is maintained at less than about 0.1 mmHg lower than the pressure on the inlet side of the product bed.

Because the secondary dryer of the present invention uses low temperatures to finish dry the food products, Applicants have increased the residence time and product bed depth. In previous secondary dryers, the residence time of the partially dried food products was between about 6 and 8 minutes. The residence time in the secondary dryer of the present invention has been increased to 12 to 14 minutes. The bed depth in previous secondary dryers was between 2 and 4 inches, whereas the bed depth in one embodiment of the present invention is between 5 and 9 inches. The increased bed depth increases the back pressure on the inlet side of the product bed. The increased back pressure has been found to increase the drying efficiency of the air that passes through the product bed.

Referring back to FIG. 1, the operating conditions of the first or primary dryer 300 can also be manipulated using a novel control scheme to reduce the formation of acrylamide during the baking process. As stated previously, the food pieces 10 entering the primary dryer are typically monolayered. Also, in one embodiment, the primary dryer is a single pass, multi-zone air impingement oven.

Previous attempts to control baking conditions in the primary dryer used temperature as the main process control variable. However, when temperature is used as a control variable, it has been found that the temperature inside the oven varies between 10° F. and 15° F. from minimum temperature to maximum temperature experienced by the food pieces. When food pieces are subjected to temperatures at the maximum variation from set point, the food pieces have been found to form acrylamide at much higher levels than previously suspected because the food surfaces can form “hotspots” where temperatures rise above the acrylamide formation temperature. In the specific case of fabricated potato chips, the hotspots can occur in a ring formation along the outside edge boundary of the dough perform. Furthermore, because the residence time of food pieces 10 inside the primary dryer is so short (typically less than 1 minute) and because it can take as long as 15 minutes to adjust the temperature inside the dryer, oven temperature is not an optimum process control variable.

Applicants herein have thus determined that controlling total water flow through the primary dryer is a better way to reduce variability due to moisture disturbances in the system. Water enters the system as constituent water of the uncooked preforms 10. The moisture content can be measured, in the case of whole food slices, or calculated, in the case of fabricated potato chip preforms made from a potato flake dough that uses added water. Moisture leaves the system in the air passing through the exhaust stream 320 of the primary dryer, and as moisture remaining in the preforms as they exit the primary dryer. The moisture leaving the system through the exhaust stream 320 is measured by an absolute humidity sensor located in the exhaust stream. The absolute humidity in the exhaust stream 320 increases when moisture input into the system increases. The moisture leaving the system in the preforms is measured using optical NIR measurement, or other online moisture measurement technique known in the art. In one embodiment, fabricated potato chip preforms preferably exit the primary dryer at a moisture content of about 9%.

In one embodiment of the present invention, the first response of the control system to a disturbance in moisture entering or leaving the system is a change in the belt speed of the primary dryer. If all other parameters are unchanged, an increase in belt speed will decrease the amount of moisture removed from the preforms, and a decrease in belt speed will increase the amount of moisture removed from the preforms. However, a change in belt speed will alter the throughput of preforms through the secondary dryer, which is a disturbance that will affect the performance of the secondary dryer. Therefore, the control system adjusts other parameters that have a slower response than belt speed in order to quickly return the belt speed back to its original setpoint. In particular, the air velocity in the impingement zone is one parameter that is adjusted to compensate for moisture disturbances. The impingement zone is the zone between the upper impingement tubes 316, which are fed by the recirculation fan 310, and the lower impingement tubes 318, which are fed by the recirculation fan 312. The primary dryer may have more than one burner and one or more recirculation fans associated with each burner. An increase in air velocity in the impingement zone will increase the drying rate of the preforms.

Additionally, when the impingement oven is a gas-fired oven, the control system adjusts the gas flow rate in the burner 314, not the overall oven temperature, in response to moisture disturbances. The gas flow rate is controlled using the gas valve position. The gas flow rate is an excellent measure of the energy input into the system, which Applicants have found to be a more reliable control variable than oven temperature. The energy input into the system can be correlated with the water flow through the system through the latent heat of vaporization and temperature change of the water. The control system is designed to maintain a constant energy input into the system per unit of water input into the system.

Thus, one embodiment of the present invention reduces the level and variability of acrylamide levels for baked food products passing through a primary dryer by adjusting the belt speed as a first response to moisture disturbances, and adjusting the air velocity and energy input into the system as second or third responses, in order to return the belt speed back to its original set point.

In one embodiment, the system of the present invention comprises a primary dryer adapted to receive food piece preforms at a first moisture content and dry them to a second moisture content, having at least one conveyor belt extending from an entrance to an exit with a belt speed, and an exhaust stream; a first control system comprising an absolute humidity sensor in said exhaust stream and a moisture sensor capable of measuring said second moisture content, wherein said control system detects a moisture disturbance in said sensors, and adjusts said belt speed as a first response to said moisture disturbance, adjusts an energy input into said primary dryer and an air velocity through said primary dryer as a second or third response to said moisture disturbance, and returns said belt speed back to a set point after said second or third response attenuates said moisture disturbance. In another embodiment, the system further comprises a secondary dryer adapted to receive said food piece preforms from said primary dryer and dry them to a third moisture content, wherein said secondary dryer comprises an exhaust stream, and a recirculation stream; and a second control system comprising an absolute humidity sensor in said exhaust stream, wherein said absolute humidity sensor detects a moisture disturbance in said secondary dryer, and said second control system adjusts the temperature inside said secondary dryer as a first response to said moisture disturbance, adjusts the recirculation stream fan speed as a second response to said moisture disturbance, adjusts the exhaust stream fan speed as a third response to said moisture disturbance and returns said temperature and recirculation stream fan speed back to a set point.

In one embodiment, the method of the present invention comprises passing said food piece preforms through a secondary dryer adapted to receive said food piece preforms from said primary dryer and dry them to a third moisture content, wherein said secondary dryer comprises an exhaust stream and a recirculation stream; and attenuating a moisture disturbance in said secondary dryer by adjusting a temperature inside said secondary dryer as a first response to said moisture disturbance, adjusting the recirculation stream flow rate as a second response to said moisture disturbance, adjusting the exhaust stream flow rate as a third response to said moisture disturbance and returning said temperature and recirculation stream flow rate back to a set point. In another embodiment, the method further comprises passing said food piece preforms through a secondary dryer adapted to receive said food piece preforms from said primary dryer and dry them to a third moisture content, wherein said secondary dryer comprises an exhaust stream and a recirculation stream; and attenuating a moisture disturbance in said secondary dryer by adjusting a temperature inside said secondary dryer as a first response to said moisture disturbance, adjusting the recirculation stream flow rate as a second response to said moisture disturbance, adjusting the exhaust stream flow rate as a third response to said moisture disturbance and returning said temperature and recirculation stream flow rate back to a set point.

While this invention has been particularly shown and described with preferred embodiment, it will be understood by those skilled in the art that various changes and form detail may be made therein without departing from the spirit and scope of the invention.

What is claimed is:

1. A system for baking food pieces comprising:
a primary dryer adapted to receive food piece preforms at a first moisture content and dry them to a second moisture content, having at least one conveyor belt extending from an entrance to an exit with a belt speed, and an exhaust stream;
a first control system comprising an absolute humidity sensor in said exhaust stream and a moisture sensor capable of measuring said second moisture content, wherein said control system detects a moisture disturbance in said sensors, and adjusts said belt speed as a first response to said moisture disturbance, adjusts an energy input into said primary dryer and an air velocity through said primary dryer as a second or third response to said moisture disturbance, and returns said belt speed back to a set point after said second or third response attenuates said moisture disturbance.

2. The system of claim 1 wherein said primary dryer is a gas fired impingement oven, and said control system adjusts said energy input by position of a gas flow valve.

3. The system of claim 1 further comprising:
a secondary dryer adapted to receive said food piece preforms from said primary dryer and dry them to a third moisture content, wherein said secondary dryer comprises an exhaust stream, and a recirculation stream; and
a second control system comprising an absolute humidity sensor in said exhaust stream, wherein said absolute humidity sensor detects a moisture disturbance in said secondary dryer, and said second control system adjusts the temperature inside said secondary dryer as a first response to said moisture disturbance, adjusts the recirculation stream fan speed as a second response to said moisture disturbance, adjusts the exhaust stream fan speed as a third response to said moisture disturbance and returns said temperature and recirculation stream fan speed back to a set point.

4. The system of claim 3 wherein said food piece preforms are fabricated potato chip preforms, and said temperature inside said secondary dryer is constrained between 110° C. and 113° C.

5. The system of claim 4 wherein said set point of said temperature is about 111.5° C.

6. The system of claim 3 wherein said secondary dryer receives said preforms as a product bed, and wherein said second control system adjusts airflow through said recirculation and exhaust streams to maintain a pressure differential above and below said product bed below about 0.1 mmHg.

7. A method for baking food pieces, said method comprising:
passing food piece preforms through a primary dryer adapted to receive said food piece preforms at a first moisture content and dry them to a second moisture content, wherein said primary dryer comprises at least one conveyor belt extending from an entrance to an exit with a belt speed having a set point, and an exhaust stream;
attenuating a moisture disturbance in said primary dryer by adjusting said belt speed as a first response to said moisture disturbance, adjusting an energy input into said primary dryer and an air velocity through said primary dryer as a second or third response to said moisture disturbance, and returning said belt speed back to said set point after said second or third response attenuates said moisture disturbance.

8. The method of claim 7 wherein said primary dryer is a gas fired impingement oven, and said adjusting said energy input comprises controlling a gas flow valve position.

9. The method of claim 7 further comprising:
passing said food piece preforms through a secondary dryer adapted to receive said food piece preforms from said primary dryer and dry them to a third moisture content, wherein said secondary dryer comprises an exhaust stream and a recirculation stream; and
attenuating a moisture disturbance in said secondary dryer by adjusting a temperature inside said secondary dryer as a first response to said moisture disturbance, adjusting the recirculation stream flow rate as a second response to said moisture disturbance, adjusting the exhaust stream flow rate as a third response to said moisture disturbance and returning said temperature and recirculation stream flow rate back to a set point.

10. The method of claim 9 wherein said food piece preforms are fabricated potato chip preforms, and said temperature inside said secondary dryer is constrained between 110° C. and 113° C.

11. The method of claim 10 wherein said temperature set point is about 111.5° C.

12. The method of claim 9 wherein said secondary dryer receives said preforms as a product bed, and wherein said method further comprises maintaining a pressure differential above and below said product bed below about 0.1 mmHg.
